(19) United States
(12) Patent Application Publication
(10) Pub. No.: US 2017/0053257 A1
(43) Pub. Date: Feb. 23, 2017

(54) SYSTEM AND METHOD FOR PROVISIONING CREDIT

(71) Applicant: EINNOVATIONS HOLDINGS PTE. LTD., Singapore (SG)

(72) Inventors: Orlando B. VEA, Makati City (PH); Angelito M. Villanueva, Makati City (PH); Agustin L. SANTIAGO, Makati City (PH)

(73) Assignee: EINNOVATIONS HOLDINGS PTE. LTD., Singapore (SG)

(21) Appl. No.: 15/306,743

(22) PCT Filed: Apr. 28, 2015
(86) PCT No.: PCT/SG2015/050086

§ 371 Date: Oct. 25, 2016

(30) Foreign Application Priority Data
Apr. 28, 2014 (SG) 10201401863X

(51) Int. Cl. G06Q 20/22; G06Q 20/34; G06Q 20/32

(52) U.S. Cl. CPC G06Q 20/22; G06Q 20/3278; G06Q 20/351

(57) ABSTRACT

A method and system of provisioning credit or facilitating the provision of credit to a subscriber of a network provider is described. The method comprises pre-identifying the subscriber for registration with a financial institution based on a set of criteria; checking if the subscriber registers with the financial institution, verifying the subscriber based on at least one unique identifier the credentials of the subscriber; linking the account; wherein the linking step comprises generating a pseudo-account number based on the at least one unique identifier; checking if the subscriber is capable of over-the-counter (OTC) transactions; and providing means for performing OTC transactions if the subscriber is not capable of OTC transactions.

### FIELD OF THE INVENTION

The present invention relates to a system and method for provisioning credit. In particular, the system and method are suited (but not limited) for the provisioning of credit to subscribers of a network operator and will be described in such context.

### BACKGROUND ART

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

With the exponential improvement in mobile device technology and the advent of the smartphone, the use and functionality of mobile devices has increased. In particular, a mobile device may be used for transactions such as and for example the transfer of funds between different accounts and/or geographical locations.

Subscribers of telecommunications carrier (‘telcos’) may be availed to different plans allowing them the flexibility to make use of the prepaid or postpaid airtime credit limit to purchase online goods and/or services. These are typically ‘billed on top’ or operator-billing partnerships that make use of the subscriber's existing airtime credit limit to purchase online or virtual goods.

However, utilization of these purchases typically “eat up” or consume the supposed airtime revenue intended for voice and/or SMS. In addition, the type of goods and services provided under these plans are limited to telecommunications network or value-added services (VAS) such as e-games, music, etc.

There exists a need to provide subscribers with credit which avail them to greater flexibility and more goods and services.

### SUMMARY OF INVENTION

The invention provides a virtual credit/wallet facility that comprise a separate credit facilitator “on-top” of the airtime credit limit for purchase of virtual and physical goods from both online and over-the-counter (OTC) transactions, to be offered to subscribers of a network provider.

For purposes of the credit limit assignment, a partner credit source that may be in the form of a financial institution, such as a bank, may be partnered with the network provider.

The credit offering via the credit facilitator and partnered financial institution is arranged to provide the first and non-traditional purchasing experience processing time compared to any other loan program in the market. This is backed by a fully electronic architecture from start to end. It eliminates the tediousness of paperwork to be accomplished and the documentation requirements to be submitted, thus simplifying the process.

In accordance with an aspect of the invention there is a system for provisioning credit to a subscriber of a network provider comprising a credit facilitator arranged to receive a request for credit from the subscriber; the credit facilitator comprises an account generator operable to generate a pseudo-account for the provision of credit; a credit source arranged in data communication with the credit facilitator, the credit source having a credit account associated with the subscriber and the pseudo-account for the provision of credit; wherein the pseudo-account is associated with a unique identifier of the subscriber.

The system enables a user to be able to purchase or transact online on credit (via a communication channel provided by the network provider for accessing the Internet) using only the unique identifier associated with the pseudo-account, instead of the credit account.

Preferably, the creation of the pseudo-account includes creation of a Near-Field Communication (NFC) tag for the subscriber. The NFC tag, when attached to a mobile device, is useful as a “form factor” for performing payments via a ‘Tap and Go’ or ‘Tap and Charge concept’

Preferably, the credit account comprises a Primary Account Number (PAN).

Preferably, a pseudo-account number associated with the pseudo-account is generated by the credit source and communicated to the credit facilitator.

Alternatively, a pseudo-account number associated with the pseudo-account is generated by the account generator based on masking the PAN.

Alternatively, a pseudo-account number associated with the pseudo-account is the unique identifier.

Preferably, the credit facilitator comprises a subscriber database for storage of at least one unique identifier related to the subscriber.

Preferably, the NFC tag is attached to a subscriber device for use in over-the-counter transaction.

Preferably, the credit source is a bank.

Preferably, the unique identifier is a MSISDN.

In accordance with another aspect of the invention there is a system to facilitate the provision of credit to a subscriber of a network provider, the network provider hosting a credit facilitator operable to pre-identify a subscriber of the network provider for registration with a credit source based on at least one criterion; create a pseudo-account for the subscriber and link the pseudo-account to a credit account held by the credit source; and check if the subscriber is capable of over-the-counter (OTC) transactions; wherein the credit account is associated with the subscriber and the pseudo-account for the provision of credit; and the pseudo-account is associated with a unique identifier of the subscriber.

Preferably, the credit facilitator further provides means for performing OTC transactions if the subscriber is not capable of OTC transactions.

Preferably, the means for performing OTC transactions is a near field communication (NFC) tag.

Preferably, the credit account comprises a Primary Account Number (PAN).

Preferably, a pseudo-account number associated with the pseudo-account is generated by the credit source and communicated to the credit facilitator.

Alternatively, a pseudo-account number associated with the pseudo-account is generated by the credit facilitator by masking the PAN.

Alternatively, a pseudo-account number associated with the pseudo-account is the unique identifier of the subscriber.

Preferably, the credit facilitator comprises a subscriber database for storage of at least one unique identifier related to the subscriber.

Preferably, the NFC tag is attached to a subscriber device for use in over-the-counter transaction.

Preferably, the credit source is a bank.

Preferably, the unique identifier is a MSISDN.

In accordance with a third aspect of the invention there is a method for facilitating the provisioning of credit to a subscriber of a network provider comprising pre-identifying the subscriber for registration with a credit source based on at least one criterion; creating a pseudo-account for the subscriber; linking the pseudo-account to a credit account held by the credit source; and checking if the subscriber is capable of over-the-counter (OTC) transactions; wherein the credit account is associated with the subscriber and the pseudo-account for the provision of credit; and the pseudo-account is associated with a unique identifier of the subscriber.

Preferably, the method further includes the step of checking if the subscriber registers with the financial institution and verifying the credentials of the subscriber based on the unique identifier.

Preferably, the method further includes the step of providing means for performing OTC transactions if the subscriber is not capable of OTC transactions.

Preferably, the means for performing OTC transactions is a near field communication (NFC) tag.

Preferably, the credit account comprises a Primary Account Number (PAN).

Preferably, a pseudo-account number associated with the pseudo-account is generated by the credit source and communicated to the credit facilitator.

Alternatively, a pseudo-account number associated with the pseudo-account is generated by the credit facilitator by masking the PAN.

Alternatively, a pseudo-account number associated with the pseudo-account is the unique identifier of the subscriber.

Preferably the unique identifier is a MSISDN of the subscriber.

### BRIEF DESCRIPTION OF THE DRAWINGS

The present invention will now be described, by way of example only, with reference to the accompanying drawings, in which:

FIG. 1 shows a flow diagram of the method for facilitating the provisioning of credit to a subscriber in accordance with an embodiment of the invention;

FIG. 2 shows a system for the provisioning of credit to a subscriber of a network provider in accordance with another embodiment of the invention;

FIG. 3 to FIG. 6 are system diagrams illustrating the different functions for a subscriber in accordance with some embodiments of the invention;

FIG. 7 and FIG. 8 are system diagrams illustrating other embodiments of the invention.

Other arrangements of the invention are possible and, consequently, the accompanying drawings are not to be understood as superseding the generality of the description of the invention.

### DESCRIPTION OF EMBODIMENTS OF THE INVENTION

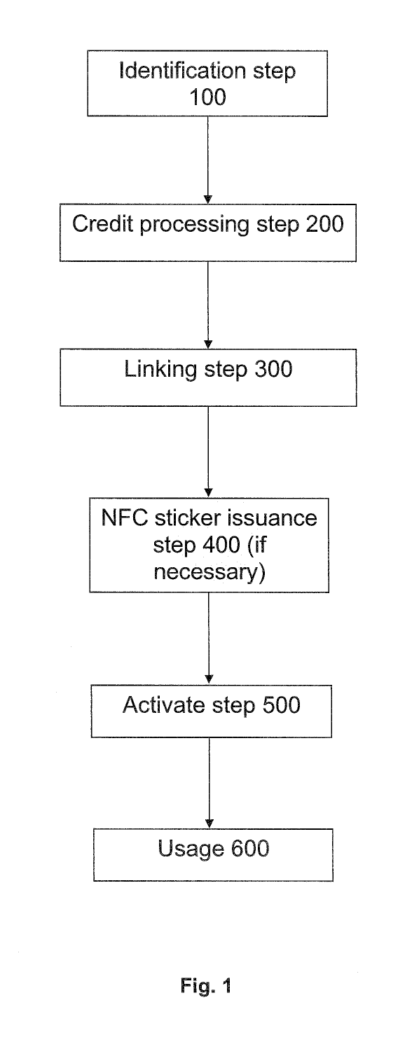

In accordance with an embodiment of the invention and with reference to FIG. 1 there is a method for provisioning credit to a subscriber of a network operator comprising a pre-identification step 100, a credit processing step 200, a linking step 300, a NFC tag (which may be in the form of a sticker) issuance step 400, an activate step 500 and a usage step 600. The subscriber may typically hold a mobile voice/data pre-paid or post-paid account with the network operator and the subscriber may be identified based on a unique identification number, such as a mobile number or MSISDN issued by the network operator. The unique identification number may be utilized for the facilitation of transaction once the mobile number or MSISDN is successfully linked to an account.

The pre-identification step 100 comprises a step to target and invite selected subscribers of a network operator who meet at least one criterion or a preliminary set of criteria to sign-in or opt-in a credit facility for provisioning credit to the subscriber. If a subscriber opts-in, the financial institution (i.e. bank) pre-screens the subscriber to check if he/she qualifies to be issued the credit, and how much credit is to be allocated or issued.

The at least one criterion or preliminary set of criteria depends on the policies and procedures of the credit facility. Such criteria may include (but is not limited to) monthly net salary, debt-to-asset ratio etc of the subscribers.

The credit-processing step 200 comprises the financial institution (i.e. partner bank) processing the credit verification based on a standard credit verification process of the partner bank with a special consideration as these were endorsed by the network operator. The network operator may comprise a telecommunications network. The partner bank will process for credit limit assignment. An account with the partner bank will be created and a credit line assigned if the credit verification step is passed. If the credit verification step fails, the request for the provisioning of credit will be rejected.

In an embodiment, the process of creating the account with the partner bank involves generation of a credit/debit card with the generation of a primary account number (PAN) where applicable.

Once the account is created and a credit limit assigned, the credit card number will be linked (step 300) to a pseudo-account number which will be the transactional account number that will be used and transmitted over the air or network, and the pseudo-account number will be used instead of a real account number which will be matched with the mobile number for his transactions. The pseudo-account number may be generated based on certain set of rule assignment of the account number that is to be agreed by the account holder and the partner bank. Alternatively, the pseudo-account number may be randomly assigned.

The transmission of the card numbers will be encrypted in a credit or transaction facility maintained by the network operator.

Once linked, the subscriber user can start requesting for credit based on the credit line assigned against his registered mobile phone number. For security, encryption algorithms may be utilized for encryption. For example, a secure hash algorithm (SHA) may be used to convert certain data being transmitted, in addition to the pseudo-account number conversion. There are hence at least two levels for ‘masking’ the account number to prevent it from being exposed.

The partner bank may be first ‘linked’ or lied up′ with the telecommunications carrier or network hosting the subscriber(s). There will be a necessary registration process for the partner bank to undergo with the telecommunications carrier.

Step 400 comprises the issuance of near-field communication (NFC) tags in the form of low-cost adhesive or stickers. These may be installed to a user's non-NFC enabled mobile phone if necessary. For mobile phones enabled with NFC technology, step 400 will not be necessary.

Step 500 is an activation step. Activation step 500 comprises a one-time validation to ensure that the created account, the NFC and the mobile phones are all connected accurately.

The above steps 300, 400 and 500 may include sub-steps such as the generation of a mobile personal identification number (mPIN); sending of SMS notification(s) about the linking of the mobile phone (and mobile identification number) with the card C2P account; and the sending of link where a subscriber can change the default mPIN. The default mPIN may be the last six (6) digits of a subscriber's tax identification number (TIN) or other forms or combinations of identification number.

At the initial approval of the new credit limit “on top”, the bank sends the card information to the credit facility server and that's where the matching to the mobile number, pseudo/tokenization and masking/encryption happens.

In step 600, the customer may start using the linked account credit facility for the purchase of goods and services, both over the Internet (i.e. online purchase) or over-the-counter (OTC) via the NFC.

A billing or settlement step 700 will be generated for the settlement of the usage of the service. The billing step involves the generation of separate bills separate and independent from the mobile usage bill generated for the mobile postpaid subscriber.

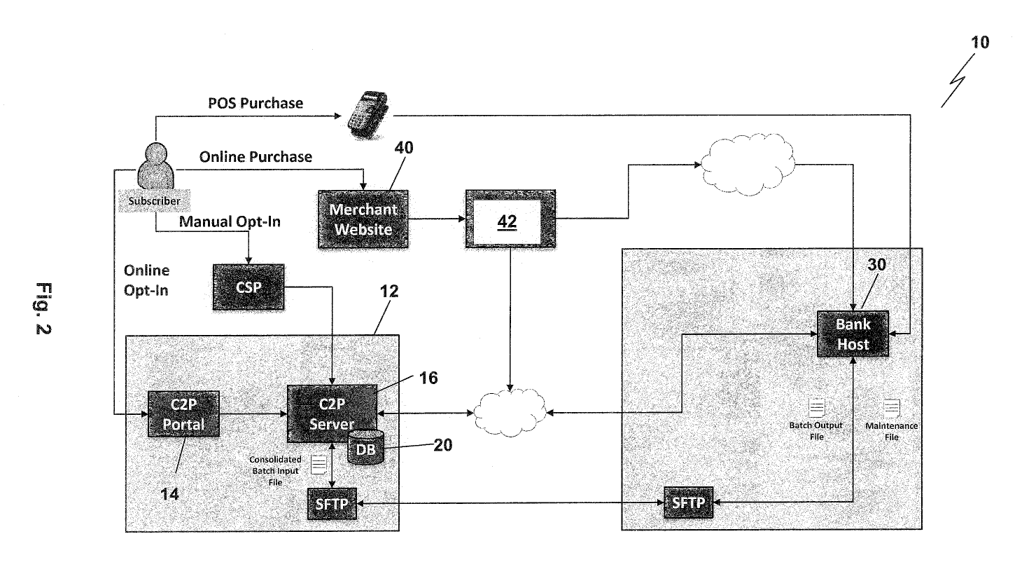

In accordance with another embodiment of the invention and with reference to FIG. 2 there comprises a system 10 for provisioning credit to a subscriber of a network provider 12. The network provider 12 may be a telecommunications carrier 12 and comprises at least a portal and/or gateway 14 to access a credit facilitator 16. Credit facilitator 16 is hosted by the telecommunications carrier 12 and may comprise a server 18 in data communication with a subscriber database 20, for storage of the unique identifier related to the subscriber.

The credit facilitator 16 is operable to, inter alia, process batch file input/output; map an unique identifier of the subscriber to an account; generation and validation of one-time password (OTP); generation and validation of mobile PIN; and SMS notifications. The credit facilitator 16 comprises an account generator operable to generate a pseudo-account for the provision of credit.

System 10 further comprises a credit source 30 for providing credit upon receipt of a request for credit from the subscriber. Credit source 30 may comprise a financial institution such as a partner bank, and may include the necessary settlement facility.

The credit source 30 is arranged in data communication with the credit facilitator 16. The credit source 30 comprises a credit account 32 associated with the subscriber and the pseudo-account for the provision of credit. The pseudo-account is associated with a unique identifier of the subscriber, such as a MSISDN of the subscribers' mobile data/voice account with the network provider 12. The credit account may be identified with a Primary Account Number (PAN) and the issuance of a credit card. An example of the PAN would be the sixteen (16) digit card alpha-numeric numbers printed on each credit card issued by the credit source.

The creation of the pseudo-account may include the creation of a Near-Field Communication (NFC) tag for the subscriber. The creation of the NFC tag in the form of sticker is relevant for example where the subscriber's mobile device does not contain in-built NFC mechanisms. In such cases, the NFC tag is attached to a subscriber device in the form of, for example, a sticker, for use in over-the-counter transaction.

The pseudo-account number associated with the pseudo-account can be generated by one or more of the following:—

a. Generated by the credit source and communicated to the credit facilitator;
b. Generated by the account generator based on masking the PAN; and/or
c. Generated using the unique identifier or is the unique identifier.

The system 10 is next described in the context of its operation.

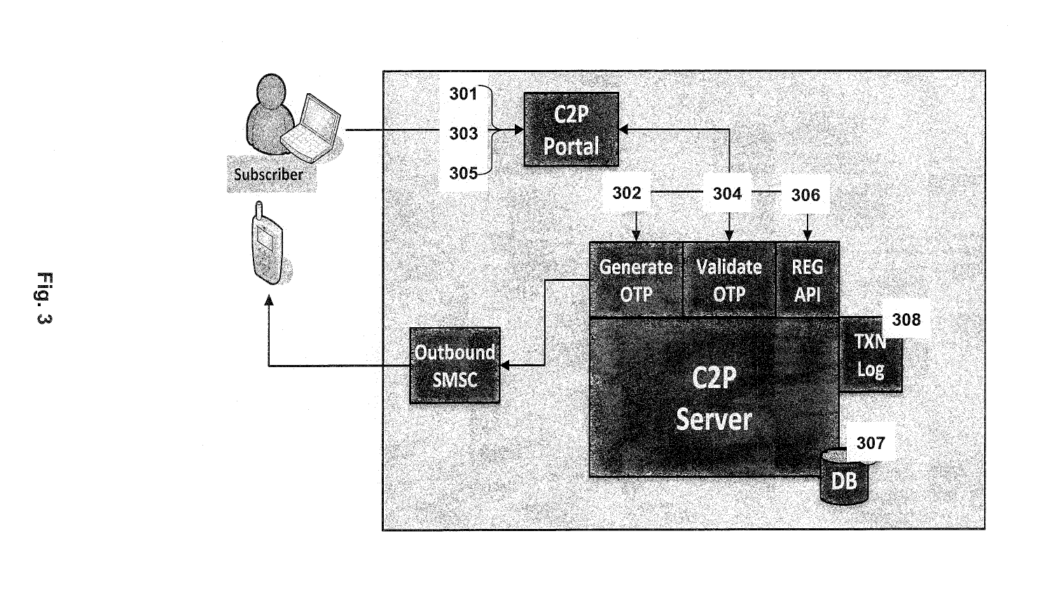

With reference to FIG. 3, the subscriber may choose to opt-in to the provision of credit service via an online opt-in web resource via a URL for example. The steps for determining the online opt-in are as follows:—

Step 301. Subscriber clicks the generated personalized URL to access the Online Opt-in web resource.
Step 302. The credit facilitator 16 generates a One-Time Password (OTP) and sends it to the subscriber via a text message such as a SMS
Step 303. The subscriber enters the received OTP in the One-Time Password web resource (typically in the form of a web-page).
Step 304. The credit facilitator 16 validates the OTP.
Step 305. The subscriber is directed to the Application Form Page and submits the required information.
Step 306. The credit facilitator 16 receives the request and performs validations.
Step 307. The credit facilitator 16 stores the information in the subscriber database 20.
Step 308. The credit facilitator 16 logs the transaction.

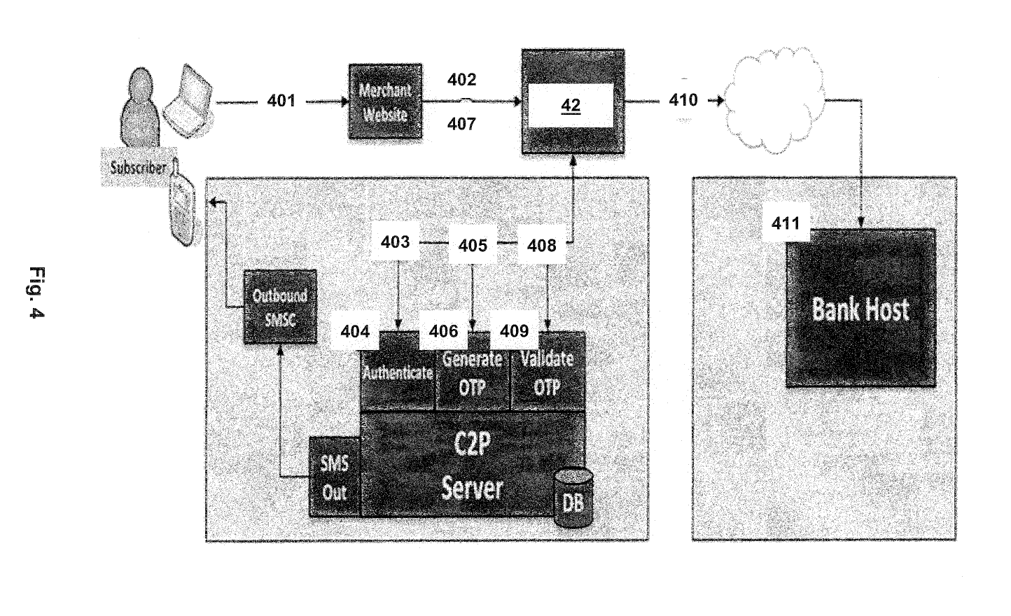

With reference to FIG. 4, the subscriber utilizes the system 10 for an online purchase with a merchant 40 in accordance with the following steps.

Step 401. Subscriber initiates a Purchase transaction via the Merchant Website 40.
Step 402. Subscriber is directed to a secured payment web resource 42 to enter his unique identifier and a personal identification number (PIN) (MSISDN & mPIN).
Step 403. the secured payment web resource 42 sends an authentication request to the credit facilitator 16.
Step 404. Credit facilitator 16 performs validations and sends response to the secured payment web resource.
Step 405 the secured payment web resource 42 sends a One-Time-Password (OTP) request to the credit facilitator 16.
Step 406. Credit facilitator 16 generates an OTP and sends it to the Subscriber via SMS.
Step 407. Credit facilitator 16 prompts the subscriber to enter the OTP received and submits the transaction.
Step 408 the secured payment web resource sends a Validate OTP request to the credit facilitator 16.
Step 409. Credit facilitator 16 validates the OTP and sends response to the secured payment web resource 42.
Step 410 the secured payment web resource sends the transaction to the credit source (for example a bank host).
Step 411. Bank Host processes the payment authorization.

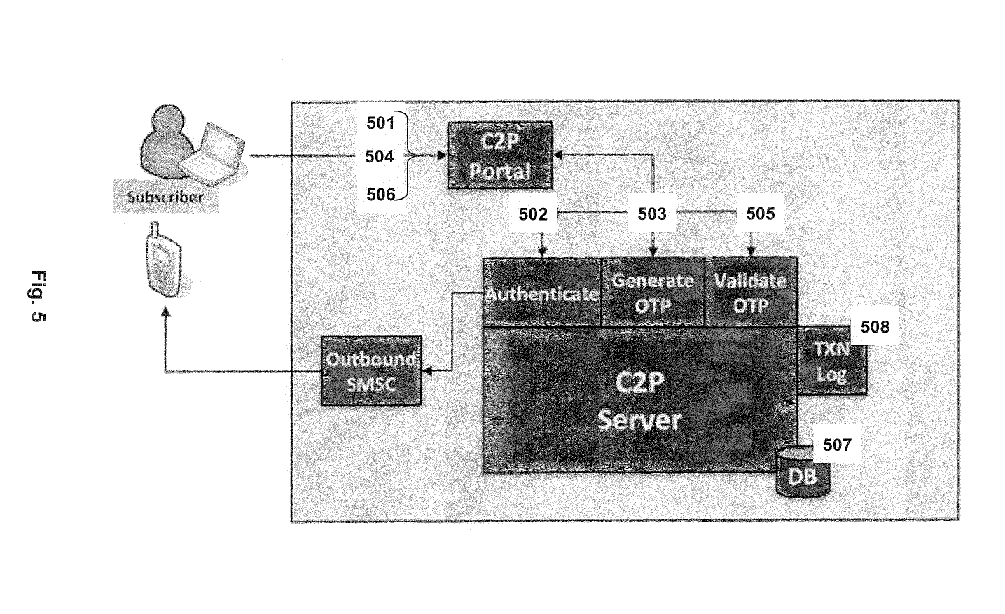

With reference to FIG. 5, the subscriber or user may change his/her mobile PIN in accordance with the following steps.

Step 501. The subscriber goes to the credit facilitator's 16 Online Portal and enters his MSISDN and mobile PIN for verification.
Step 502. The credit facilitator 16 validates the account details entered by the Subscriber.
Step 503. Credit facilitator 16 generates a One-Time Password (OTP) and sends it to the Subscriber via SMS.
Step 504. The subscriber enters the received OTP in the One-Time Password web resource (webpage).
Step 505. The credit facilitator 16 validates the OTP.
Step 506. The subscriber is directed to a Change m-PIN web resource (webpage) and submits the required information.
Step 507. The credit facilitator 16 receives the request and updates the Subscriber's mPIN in the database.
Step 508. The credit facilitator 16 logs the transaction.

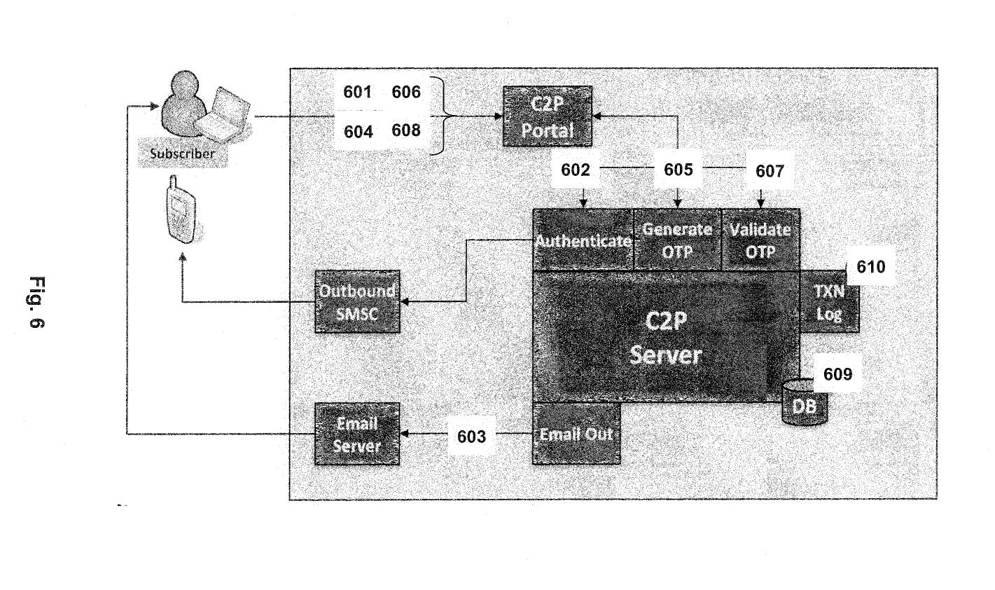

With reference to FIG. 6, when the subscriber or user forgets his m-PIN, he may request for a new m-PIN in accordance with the following steps.

Step 601. The subscriber goes to the online portal of credit facilitator 16 and enters his unique identifier (i.e. MSISDN).
Step 602. The credit facilitator 16 validates the MSISDN entered by the Subscriber.
Step 603. The credit facilitator 16 composes a message via another communication channel (e.g. e-mail message) with the personalized URL (to access the Forgot mPIN webpage) and sends it to the Subscriber.
Step 604. Subscriber clicks the generated personalized URL to access the Forgot mPIN webpage.
Step 605. The credit facilitator 16 generates a One-Time Password (OTP) and sends it to the Subscriber via SMS.
Step 606. The subscriber enters the received OTP in the One-Time Password Page.
Step 607. The credit facilitator 16 validates the OTP.
Step 608. The subscriber is directed to the Forgot m-PIN Page and submits the required information.
Step 609. The credit facilitator 16 receives the request and updates the Subscriber's mPIN in the database.
Step 610. The credit facilitator 16 logs the transaction.

In accordance with another embodiment of the invention, there comprises a method for facilitating the provisioning of credit to a subscriber of a network provider comprising the steps of pre-identifying the subscriber for registration with a credit source based on at least one criterion; creating a pseudo-account for the subscriber; linking the pseudo-account to a credit account held by the credit source; and checking if the subscriber is capable of over-the-counter (OTC) transactions; wherein the credit account is associated with the subscriber and the pseudo-account for the provision of credit; and the pseudo-account is associated with a unique identifier of the subscriber. The various steps for pre-identification, creation, linkage and checks may correspond to steps 100, 200, 300, 400, 500 and 600 as described in earlier embodiments and will not be further elaborated.

In other embodiments which may be combined with one or more of the above embodiments, the credit facilitator 16 may be a fully-digital and cardless credit facility, targeting current and future subscribers accounts. The credit facilitator 16 is aimed to provide a separate credit limit “credit-on-top” of their airtime credit line for purchase of goods and services, virtual or physical, via online or over-the-counter, using only the mobile phone number (MIN) as an unique identifier. This allows for greater flexibility, convenience, speed and adoption of seamless, mobile technologies to be experienced by the subscribers.

By tapping the existing and future subscribers (whether prepaid or postpaid) of telecommunications carrier, the invention achieves at least the following advantages:—
Frictionless payments
Mobile technology-based
Seamless and “hi-tech” Customer experience
Secure, through use of a pseudo account for OTC
Unique value proposition:
Higher spending limit subject to credit scoring with issuing bank
No submission of income documents, based on the postpaid behavior
No mobile apps to download
Use for online, mobile and over-the-counter
Quick checkout for online purchases

It is to be appreciated that the system, also known as the ‘charge2phone’ service, although suited for postpaid subscribers, may be provided to other types of subscribers. For example, pre-paid subscribers or customers having certain demographics stored with the bank partner may be invited for registration. However, additional documents may be necessary for the credit processing stage 200 to verify the credit standing of such pre-paid subscribers. Non-subscribers may be incorporated into the system if the network operators have tie-ups with other network operator(s) and may accept/process mobile numbers or MSISDNs of other network operator(s).

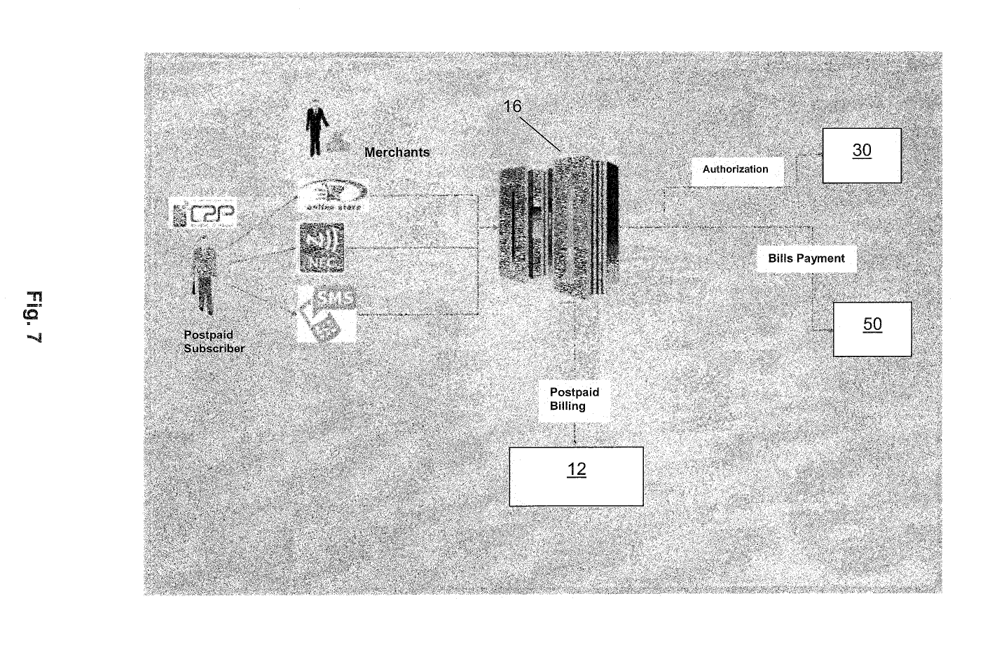

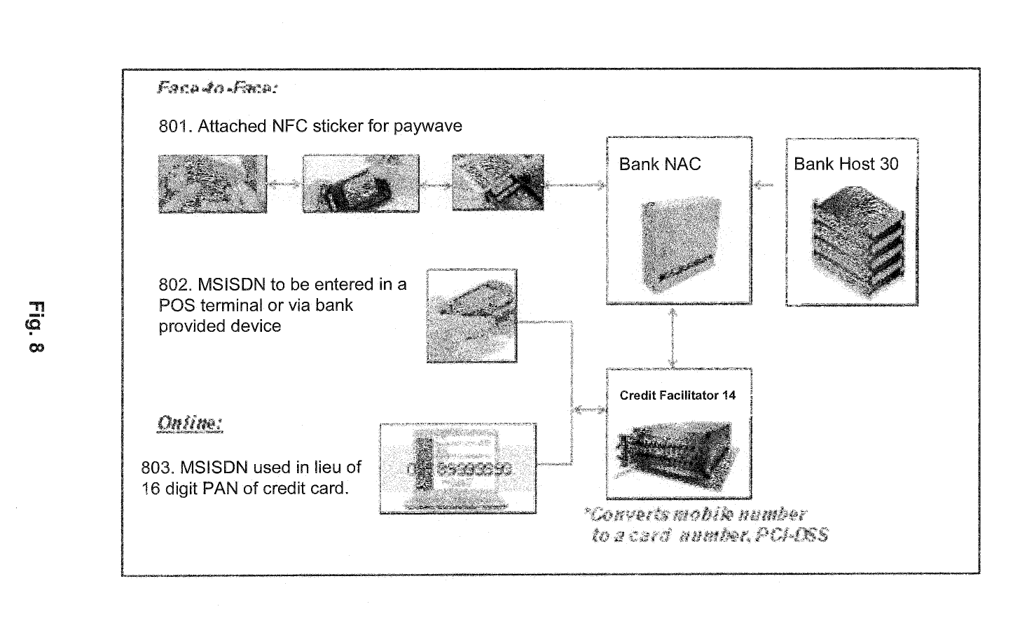

In other embodiments, the steps 100, 200, 300, 400, 500, 600 and 700 may be implemented via the system architecture as shown in FIGS. 7 and 8. In particular, a registered user of the ‘charge2phone’ service having the attached NFC tag or ‘sticker’ may use the mobile phone as if it is a credit card to be read by a NFC reader for transaction. Further, in light of the generation of the pseudo-account and number, instead of keying the actual account number, the mobile MIN or MSISDN of the registered user may be keyed into a POS device. The registered user may also perform usual online Internet transactions using the mobile number or pseudo-account number instead of using the actual account number. The mobile number or MSISDN is correlated to or converted to a card number using Payment Card Industry

Data Security Standard (PCI DSS). The system architecture may be utilized for credit provision to a postpaid subscriber for remittance to a remittance centre 50, and the subscriber may then be billed in the next postpaid bill.

Using FIG. 8 as an example, the attached NFC sticker may be utilized for a transaction via a ‘tap and charge’ action such as Paywave™ (step 801).

The MSISDN as a pseudo-account number is entered in a Point-of-sale terminal or via another device functioning as a mobile POS (step 802). The MSISDN is used in lieu of the actual account number (e.g. sixteen (16) digit PAN account number associated with the card). The MSISDN is sent to the credit facilitator 16 for verification and conversion to the actual card number using PCI DSS (step 803).

As mentioned in the various embodiments, there are three options as to the generation of pseudo-account and pseudo-account numbers based on how the credit facilitator 16 was set up as follows:—

The credit source 30 creates the pseudo account number and that is the one sent to the credit facilitator for storage and encryption; the actual sixteen (16) alphanumeric PAN or card number is obtained and the pseudo-account number is hashed or assigned by the credit facilitator 16; and the mobile identifier or number (in the form of a MSISDN for example) or a variant is used as the pseudo-account number.

All three options are available depends on the capabilities of the credit source 30 or the network provider 12.

The actual account will remain with the credit source 30 or bank. The transmission of the card number will be encrypted in the credit facilitator 16.

From the subscriber's perspective, he is entering an unique identifier (in the form of his mobile number) to make an online purchase, but at the backend, a form of tokenization between the credit facilitator's 16 infrastructure and the payment processor for the translation to the real credit card number will be made. An authentication will also be made before approval passing through a credit card, e.g. Visa™ or Mastercard™ network, and ending up to the bank's 30 host system for the approval.

At the initial approval of the new credit limit “on top”, the bank 30 sends the card information to credit facilitator 16 and that is where the matching to the mobile number, pseudo/tokenization and masking/encryption happens.

It should be appreciated by the person skilled in the art that variations and combinations of features described above, not being alternatives or substitutes, may be combined to form yet further embodiments falling within the intended scope of the invention.

1. A system for provisioning credit to a subscriber of a network provider comprising
a credit facilitator arranged to receive a request for credit from the subscriber; the credit facilitator comprises an account generator operable to generate a pseudo-account for the provision of credit;
a credit source arranged in data communication with the credit facilitator, the credit source having a credit account associated with the subscriber and the pseudo-account for the provision of credit;
wherein the pseudo-account is associated with a unique identifier of the subscriber.

2. The system according to claim 1, wherein the creation of the pseudo-account includes creation of a Near-Field Communication (NFC) tag for the subscriber.

3. The system according to claim 1, wherein the credit account comprises a Primary Account Number (PAN).

4. The system according to claim 1, wherein a pseudo-account number associated with the pseudo-account is generated by the credit source and communicated to the credit facilitator.

5. The system according to claim 3, wherein a pseudo-account number associated with the pseudo-account is generated by the account generator based on masking the PAN.

6. The system according to claim 1, wherein a pseudo-account number associated with the pseudo-account is the unique identifier.

7. (canceled)

8. The system according to claim 2, wherein the NFC tag is attached to a subscriber device for use in over-the-counter transaction.

9. (canceled)

10. The system according to claim 1, wherein the unique identifier is a MSISDN.

11. A system to facilitate the provision of credit to a subscriber of a network provider, the network provider hosting
a credit facilitator operable to
pre-identify a subscriber of the network provider for registration with a credit source based on at least one criterion;
create a pseudo-account for the subscriber and link the pseudo-account to a credit account held by the credit source; and
check if the subscriber is capable of over-the-counter (OTC) transactions;
wherein the credit account is associated with the subscriber and the pseudo-account for the provision of credit; and the pseudo-account is associated with a unique identifier of the subscriber.

12. The system according to claim 11, wherein the credit facilitator further provide means for performing OTC transactions if the subscriber is not capable of OTC transactions.

13. The system according to claim 12, wherein the means for performing OTC transactions is a near field communication (NFC) tag.

14. The system according to claim 11, wherein the credit account comprises a Primary Account Number (PAN).

15. The system according to claim 11, wherein a pseudo-account number associated with the pseudo-account is generated by the credit source and communicated to the credit facilitator.

16. The system according to claim 14, wherein a pseudo-account number associated with the pseudo-account is generated by the credit facilitator by masking the PAN.

17. The system according to claim 11, wherein a pseudo-account number associated with the pseudo-account is the unique identifier of the subscriber.

18. (canceled)

19. The system according to claim 13, wherein the NFC tag is attached to a subscriber device for use in over-the-counter transaction.

20. (canceled)

21. The system according to claim 11, wherein the unique identifier is a MSISDN.

22. A method for facilitating the provisioning of credit to a subscriber of a network provider comprising
pre-identifying the subscriber for registration with a credit source based on at least one criterion;
creating a pseudo-account for the subscriber;
linking the pseudo-account to a credit account held by the credit source; and
checking if the subscriber is capable of over-the-counter (OTC) transactions;
wherein the credit account is associated with the subscriber and the pseudo-account for the provision of credit; and the pseudo-account is associated with a unique identifier of the subscriber.

23. The method according to claim 22, further including the step of checking if the subscriber registers with the financial institution and
verifying the credentials of the subscriber based on the unique identifier;

24. The method according to claim 22, further including the step of providing means for performing OTC transactions if the subscriber is not capable of OTC transactions.

25. The method according to claim 24, wherein the means for performing OTC transactions is a near field communication (NFC) tag.

26. The method according to claim 22, wherein the credit account comprises a Primary Account Number (PAN).

27. The method according to claim 22, wherein a pseudo-account number associated with the pseudo-account is generated by the credit source and communicated to the credit facilitator.

28. The method according to claim 26, wherein a pseudo-account number associated with the pseudo-account is generated by the credit facilitator by masking the PAN.

29. The method according to claim 22, wherein a pseudo-account number associated with the pseudo-account is the unique identifier of the subscriber.

30. The method according to claim 22, wherein the unique identifier is a MSISDN.
